(19) United States
(12) Patent Application Publication
(10) Pub. No.: US 2026/0178921 A1
(43) Pub. Date: Jun. 25, 2026

(54) SYSTEMS AND METHODS FOR PROTECTING PRIVATE ATTRIBUTES USING DATA-LEVEL GROUPING AND RANDOMIZATION

(71) Applicant: JPMORGAN CHASE BANK, N.A., New York, NY (US)

(72) Inventors: Yizhuo CHEN, Champaign, IL (US); Shaohan HU, Yorktown Heights, NY (US); Richard CHEN, Baldwin Place, NY (US); Hsiang HSU, Boston, MA (US); Marco PISTOIA, New York, NY (US)

(21) Appl. No.: 18/990,011

(22) Filed: Dec. 20, 2024

(51) Int. Cl. G06N 3/09

(52) U.S. Cl. CPC G06N 3/09

(57) ABSTRACT

Systems and methods for protecting private attributes using data-level grouping and randomization are disclosed. A method may include: receiving, by a computer program executed by an electronic device, an identification of a sensitive attribute to suppress and an identification of useful attributes to retain in a plurality of samples; training, by the computer program, a neural network to extract a plurality of features from the plurality of samples; receiving, by the computer program, a new sample to process; extracting, by the computer program and using the neural network, a feature in the new sample; identifying, by the computer program, a subset of the plurality of samples having the feature; randomly selecting, by the computer program, one of the samples from the subset of samples; and returning, by the computer program, the selected sample; wherein the selected sample identifies the useful attribute and does not identify the sensitive attribute.

### BACKGROUND OF THE INVENTION

### 1. Field of the Invention

Embodiments generally relate to systems and methods for protecting private attributes using data-level grouping and randomization.

### 2. Description of the Related Art

The growth of modern machine learning (ML) services has made data sharing increasingly common. Typically, ML service providers first collect data from users through various sensors and then analyze the data with a model to offer specific services to the user. The collected data, however, often contains sensitive or private information that users do not want to share with the service providers. For example, indoor people-counting services might require installing a camera in a room to capture and analyze the photos to count the number of people present. These can also reveal other potentially sensitive and private information about the users, such as their gender, ethnicity, and emotions.

### SUMMARY OF THE INVENTION

Systems and methods for protecting private attributes using data-level grouping and randomization are disclosed. According to an embodiment, a method may include: (1) receiving, by a computer program executed by an electronic device, an identification of a sensitive attribute to suppress and an identification of useful attributes to retain in a plurality of samples; (2) training, by the computer program, a neural network to extract a plurality of features from the plurality of samples; (3) receiving, by the computer program, a new sample to process; (4) extracting, by the computer program and using the neural network, a feature in the new sample; (5) identifying, by the computer program, a subset of the plurality of samples having the feature; (6) randomly selecting, by the computer program, one of the samples from the subset of samples; and (7) returning, by the computer program, the selected sample; wherein the selected sample identifies the useful attribute and does not identify the sensitive attribute.

In one embodiment, the plurality of samples and the received samples comprise images.

In one embodiment, the features comprise unidimensional random features.

In one embodiment, the method may also include: receiving, by the computer program, an identification of a useful attribute to retain; wherein the neural network may be trained to minimize a cross-entropy loss of predicting the useful attribute.

In one embodiment, the method may also include: sorting, by the computer program, outputs of the neural network.

In one embodiment, the method may also include: mapping, by the computer program, the sorted outputs of the neural network to features according to their sensitive attributes.

According to another embodiment, a non-transitory computer readable storage medium may include instructions stored thereon, which when read and executed by one or more computer processors, cause the one or more computer processors to perform steps comprising: receiving an identification of a sensitive attribute to suppress and an identification of useful attributes to retain in a plurality of samples; training a neural network to extract a plurality of features from the plurality of samples; receiving a new sample to process; extracting, using the neural network, a feature in the new sample; identifying a subset of the plurality of samples having the feature; randomly selecting one of the samples from the subset of samples; and returning the selected sample; wherein the selected sample identifies the useful attribute and does not identify the sensitive attribute.

In one embodiment, the plurality of samples and the received samples comprise images.

In one embodiment, the features comprise unidimensional random features.

In one embodiment, the non-transitory computer readable storage medium may also include instructions stored thereon, which when read and executed by the one or more computer processors, cause the one or more computer processors to perform steps comprising: receiving an identification of a useful attribute to retain; wherein the neural network may be trained to minimize a cross-entropy loss of predicting the useful attribute.

In one embodiment, the non-transitory computer readable storage medium may also include: sorting outputs of the neural network.

In one embodiment, the non-transitory computer readable storage medium may also include: mapping the sorted outputs of the neural network to features according to their sensitive attributes.

According to another embodiment, a system may include a database comprising a plurality of samples; an electronic device executing a computer program; and a user electronic device executing a user computer program in communication with the computer program. The computer program may be configured to receive, from the user computer program, an identification of a sensitive attribute to suppress and an identification of useful attributes to retain in the plurality of samples; the computer program may be configured to train a neural network to extract a plurality of features from the plurality of samples; the computer program may be configured to receive a new sample to process; the computer program may be configured to extract, using the neural network, a feature in the new sample; the computer program may be configured to identify a subset of the plurality of samples having the feature; the computer program may be configured to randomly select one of the samples from the subset of samples; and the computer program may be configured to return the selected sample; wherein the selected sample identifies the useful attribute and does not identify the sensitive attribute.

In one embodiment, the plurality of samples and the received samples comprise images.

In one embodiment, the features comprise unidimensional random features.

In one embodiment, the computer program may be configured to receive an identification of a useful attribute to retain, and the neural network may be trained to minimize a cross-entropy loss of predicting the useful attribute.

In one embodiment, the computer program may be configured to sort outputs of the neural network.

In one embodiment, the computer program may be configured to map the sorted outputs of the neural network to features according to their sensitive attributes.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for protecting private attributes using data-level grouping and randomization according to an embodiment.

FIG. 2 depicts a method for protecting private attributes using data-level grouping and randomization according to an embodiment.

FIG. 3 depicts an exemplary computing system for implementing aspects of the present disclosure.

### DETAILED DESCRIPTION OF PREFERRED EMBODIMENTS

Embodiments are directed to systems and methods for protecting private attributes using data-level grouping and randomization.

There are various approaches for removing a sensitive attribute from collected data while maintaining the utility of the data for downstream tasks. Most of these are based on training an adversarial sensitive attribute classifier, which make them unable to provide guaranteed privacy protection performance.

Embodiments may provide guaranteed privacy protection performance by strategically grouping a sample having a useful attribute with other samples having different classes of the useful attribute, and randomly selecting one of the samples. For example, for a useful attribute of the number of people in an image sample, the group may include images with the same number of people in the image but with different sexes.

Thus, the useful attribute may be returned, while sensitive attributes cannot be inferred.

As used herein, capital letters (e.g., X, S) are used to denote random variables, and their corresponding lower-case letters (e.g., x, s) are used to denote the realization of random variables. P(⋅) is used to denote probability distributions (e.g., P(X)), among which P_{data}(⋅) is used to indicate that this distribution is purely determined by a dataset and can be readily calculated. P_{θ}(⋅) is used to indicate that this distribution is parameterized by neural network θ and can be calculated by forward propagation.

Specifically, an adversarial classifier may be trained to correctly classify sensitive attributes, S, from transformed data, X′, while the data transformation model tries to prevent the adversarial classifier from making a correct classification. Although this approach can be interpreted as estimating and then minimizing the mutual information I(X′; S), where X′ is the transformed data it, unavoidably fails to provide any guarantee on the protection performance. This is because the protector can only train a data transformation model that can fool the adversarial classifier they use. If the attacker can train a better, more generalizable adversarial classifier than the one used by the protector (e.g., by using larger datasets, better machine learning techniques, or more computation power), then the attacker can still correctly infer the sensitive attributes.

As used herein, capital letters are used to identify random variables, and lowercase letters are used to identify a realization of random variable. For example, X is used to denote plurality “samples,” and x is used to denote “a sample.”

A dataset P(X) may include a sensitive attribute, S, and each sensitive attribute may have M classes. For example, the sensitive attribute such as “sex” has two classes: “male” and “female.” When an original sample, x, is drawn from the dataset, it may be strategically grouped with other samples in the dataset that have different classes of the sensitive attribute, and one of the samples, x′, may be randomly chosen. The grouping and randomization strategies are selected such that it is impossible to accurately infer which sample in the group is the original sample of x′, and thus impossible to infer the class of sensitive attribute from x′.

Embodiments may enforce the requirement that no information from the sensitive attribute is included in the sample in an adversarial-free way by altering the design of a data transformation model P_{θ}(X′|X) using, for example, grouping and randomization.

Although embodiments may be described in the context of samples that are images, it should be recognized that it may be used with other modalities as well, such as audios, human activity sensory data.

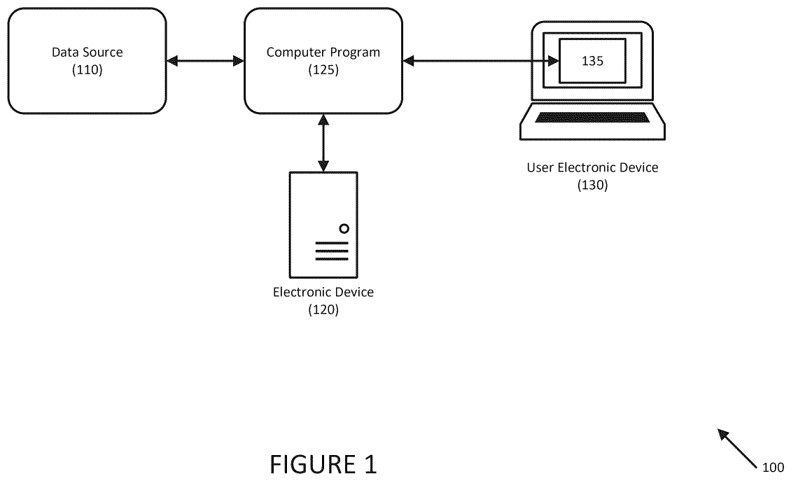

Referring to FIG. 1, a system for protecting private attributes using data-level grouping and randomization is disclosed according to an embodiment. System 100 may include data source 110, which may be a system that may provide data to be processed, electronic device 120, such as a server (e.g., physical and/or cloud-based), a computer (e.g., workstation, desktop, laptop, notebook, tablet, etc.), etc., executing computer program 125. Computer program 125 may be data-level grouping and randomization to protect private attributes.

System 100 may further include user electronic device 130, which may execute user computer program 135. User electronic device 130 may be a server, a computer, a smart device (e.g., a smart phone, a smart watch, etc.), an Internet of Things appliance, etc. It may further include downstream systems.

User computer program 135 may receive the processed data from computer program 135, and may store, analyze, or further share the data to extract useful information and help with decision making.

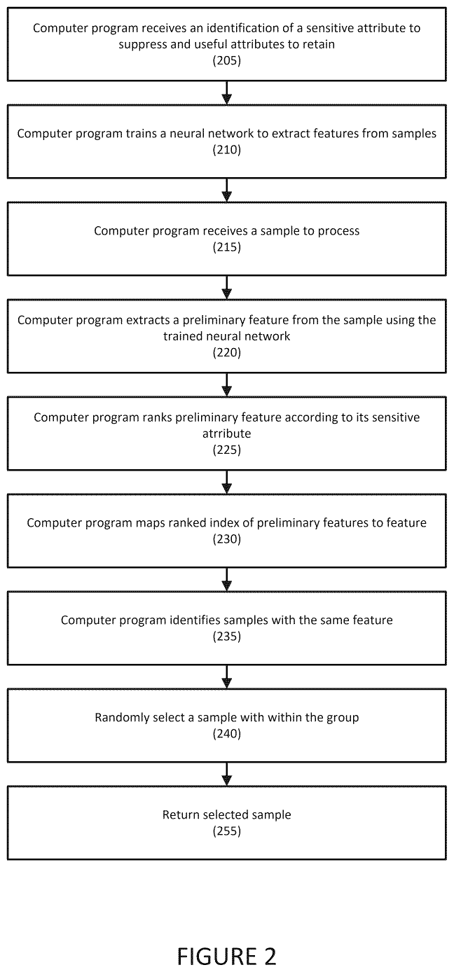

Referring to FIG. 2, a method for protecting private attributes using data-level grouping and randomization is disclosed according to an embodiment.

In step 205, a computer program executed by an electronic device may receive, from a user, an identification of one of a plurality of sensitive attributes, S, as a sensitive attribute to suppress in a plurality of samples X, and an identification of one or more of a plurality of the attributes as useful attributes, U, to retain. For example, the sensitive and/or useful attributes may be received in any suitable manner. For example, for an image sample, the computer program may receive, from a user, a selection to suppress the attribute of the sex of the people within the image, but may retain the number of people within the image.

In one embodiment, the identification of the sensitive attribute to suppress and/or the useful attributes to retain may be provided to the computer program during training.

In one embodiment, the user may only identify the sensitive attribute to suppress.

In step 210, the computer program may train a neural network to extract a plurality of features, Z, from a plurality of samples, X. The features may be random variables, such as a uniformly distributed random variables.

In one embodiment, gradient descent may be used to train the neural network. In one embodiment, the neural network may have a layered structure.

In general, features are abstract, wholistic description of the samples that are only understandable to computer, such as a vector (e.g., [0.132, 0,534, 0.665, . . . ]). The features may be the intermediate results of one of the intermediate layers of the neural network.

Once the neural network is trained, features in a new sample may be determined by the neural network. The features may be disjoint for the samples within the same class of suppressed attribute.

According to Data Processing Inequity, which is described in Beaudry, Normand, “An intuitive proof of the data processing inequality,” Quantum Information & Computation (2012), the disclosure of which is hereby incorporated by reference in its entirety, the requirement that no information (I) from the sensitive attribute is included in the sample (i.e., I(X′; S)=0) can be achieved by ensuring that I(Z; S)=0.

The neural network may be trained to minimize a loss function using standard gradient descent techniques. The loss function may be the cross-entropy loss of predicting useful attributes in order to ensure that the features contain information about useful attributes.

For example, P(Z) may be set as a simple distribution U(0, 1), and then P(Z|S=sᵢ) may be set to be equal to P(Z) for i∈1, . . . , M, where sᵢ is the i-th class for S.

In step 215, the computer program may receive a new sample, x, to process. For example, the computer program may receive an image in which the identified sensitive attribute is to be suppressed.

In step 220, the computer program may extract a preliminary feature, f_{θ}(x_{i,j}), from the plurality of features, Z, of the new sample x using the trained neural network. For example, the computer program may provide the new sample, x, to the trained neural network, and the trained neural network may return the preliminary feature as the output of the neural network.

Next, in step 225, the computer program may adjust or modify the output of the neural network according to the sample's sensitive attribute by sorting and tuning. Samples with different classes of sensitive attributes may be adjusted differently.

For example, the outputs of the neural network may be sorted as follows:

$${r}_{i , j} = {sort}_{i} ( {f}_{θ} ( {x}_{i , j} ) )$$

where θ is the function implemented as a neural network. This returns the sorted index r_{i,j}, where the outputs may be sorted in an increasing value.

In step 230, the sorted index r_{i,j} may be mapped to the feature Z. Since the subset of samples with class sᵢ, namely P(X|S=sᵢ) is a discrete distribution, P(Z|S=sᵢ)=P(Z) may be achieved by setting:

$$P ( Z \vert X = {x}_{i , j} ) = U ( \frac{{r}_{i , j} - 1}{{N}_{i}} , \frac{{r}_{i , j}}{{N}_{i}} )$$

where x_{i,j}∈ [symbol] ^{d} is a sample drawn from the subset with class sᵢ, namely P(X=x_{i,j}|S=sᵢ)=1/Nᵢ for j∈1, . . . , Nᵢ, Nᵢ is the number of samples in subset P(X|S=sᵢ), f_{θ}: [symbol] ^{d}→ [symbol] is a function mapping x_{i,j} to a real number, parameterized by neural network θ. r_{i,j}=sortᵢ(f_{θ}(x_{i,j})) denotes the sorted index of f_{θ}(x_{i,j}) in the i-th sorted list, which means that r_{i,j} ∈1, . . . , Nᵢ.

Thus, when suppressing a sensitive attribute from x_{i,j}, it is first mapped to the feature space by sampling z˜P(Z|X=x_{i,j}). Since there are M−1 other samples with a distinct sensitive attribute that can also be mapped to the feature z, the feature contains no information about the sensitive attribute. This can be seen as these M samples are grouped together, and z only contains the information about the group, but not information to distinguish among the M samples.

In step 235, the computer program may retrieve other samples from the dataset that have similar features. For example, the computer program may identify other samples in the dataset that have similar features as the new sample. At this point, the features of all samples may be determined and may be calculated for future reference.

The computer program may then group the new sample and the identified samples. For example, the samples may be logically grouped, and one sample may be part of multiple groups.

In step 240, the computer program may randomly select one of the samples within the identified group of samples.

For example, the feature z may be mapped back to the original space by randomly choosing one sample inside the group based on its probability of being accountable for generating the feature z. This may be formally written as P(X′|Z)=P(X|Z), where P(X|Z) is the posterior distribution of X given Z, which is a discrete distribution with M options. I(X;X′)=0 holds regardless of the specific way of designing the conditional distribution P(X′|Z).

In step 255, the computer program may provide the selected sample to, for example, a user computer program, a downstream system, etc. Continuing with the people counting example, the downstream system may include people counting algorithms and other indoor environment analysis algorithms. The sensitive attribute will not be leaked regardless of the selection policy.

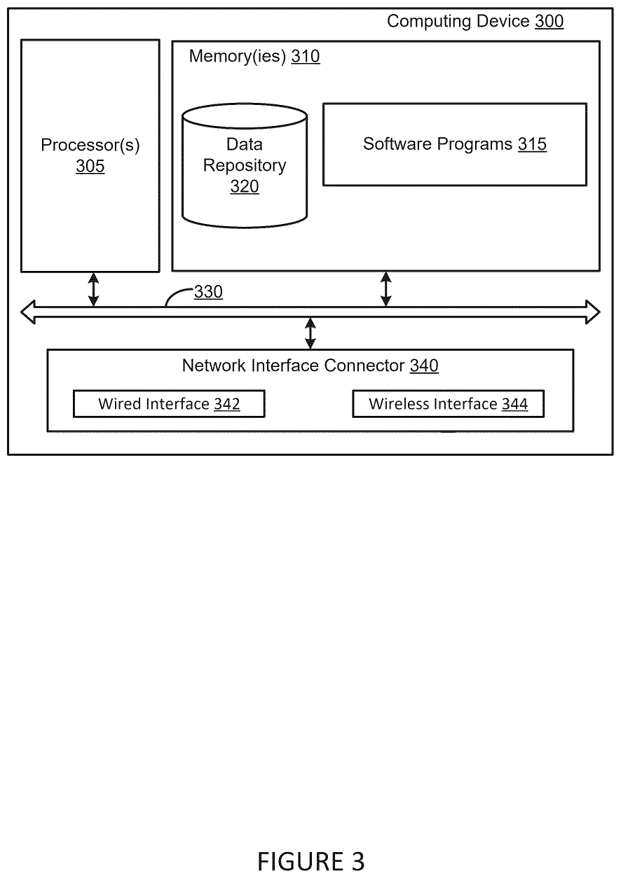

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program executed by an electronic device, an identification of a sensitive attribute to suppress and an identification of useful attributes to retain in a plurality of samples;
training, by the computer program, a neural network to extract a plurality of features from the plurality of samples;
receiving, by the computer program, a new sample to process;
extracting, by the computer program and using the neural network, a feature in the new sample;
identifying, by the computer program, a subset of the plurality of samples having the feature;
randomly selecting, by the computer program, one of the samples from the subset of samples; and
returning, by the computer program, the selected sample;
wherein the selected sample identifies the useful attribute and does not identify the sensitive attribute.

2. The method of claim 1, wherein the plurality of samples and the received samples comprise images.

3. The method of claim 1, wherein the features comprise unidimensional random features.

4. The method of claim 1, further comprising:
receiving, by the computer program, an identification of a useful attribute to retain;
wherein the neural network is trained to minimize a cross-entropy loss of predicting the useful attribute.

5. The method of claim 1, further comprising:
sorting, by the computer program, outputs of the neural network.

6. The method of claim 5, further comprising:
mapping, by the computer program, the sorted outputs of the neural network to features according to their sensitive attributes.

7. A non-transitory computer readable storage medium, including instructions stored thereon, which when read and executed by one or more computer processors, cause the one or more computer processors to perform steps comprising:
receiving an identification of a sensitive attribute to suppress and an identification of useful attributes to retain in a plurality of samples;
training a neural network to extract a plurality of features from the plurality of samples;
receiving a new sample to process;
extracting, using the neural network, a feature in the new sample;
identifying a subset of the plurality of samples having the feature;
randomly selecting one of the samples from the subset of samples; and
returning the selected sample;
wherein the selected sample identifies the useful attribute and does not identify the sensitive attribute.

8. The non-transitory computer readable storage medium of claim 7,
wherein the plurality of samples and the received samples comprise images.

9. The non-transitory computer readable storage medium of claim 7, wherein the features comprise unidimensional random features.

10. The non-transitory computer readable storage medium of claim 7, further including instructions stored thereon, which when read and executed by the one or more computer processors, cause the one or more computer processors to perform steps comprising:
receiving an identification of a useful attribute to retain;
wherein the neural network is trained to minimize a cross-entropy loss of predicting the useful attribute.

11. The non-transitory computer readable storage medium of claim 7, further including instructions stored thereon, which when read and executed by the one or more computer processors, cause the one or more computer processors to perform steps comprising:
sorting outputs of the neural network.

12. The non-transitory computer readable storage medium of claim 11, further including instructions stored thereon, which when read and executed by the one or more computer processors, cause the one or more computer processors to perform steps comprising:
mapping the sorted outputs of the neural network to features according to their sensitive attributes.

13. A system, comprising:
a database comprising a plurality of samples;
an electronic device executing a computer program; and
a user electronic device executing a user computer program in communication with the computer program;
wherein:
the computer program is configured to receive, from the user computer program, an identification of a sensitive attribute to suppress and an identification of useful attributes to retain in the plurality of samples;
the computer program is configured to train a neural network to extract a plurality of features from the plurality of samples;
the computer program is configured to receive a new sample to process;
the computer program is configured to extract, using the neural network, a feature in the new sample;
the computer program is configured to identify a subset of the plurality of samples having the feature;
the computer program is configured to randomly select one of the samples from the subset of samples; and
the computer program is configured to return the selected sample;
wherein the selected sample identifies the useful attribute and does not identify the sensitive attribute.

14. The system of claim 13, wherein the plurality of samples and the received samples comprise images.

15. The system of claim 13, wherein the features comprise unidimensional random features.

16. The system of claim 13, wherein the computer program is configured to receive an identification of a useful attribute to retain, and the neural network is trained to minimize a cross-entropy loss of predicting the useful attribute.

17. The system of claim 13, wherein the computer program is configured to sort outputs of the neural network.

18. The system of claim 17, wherein the computer program is configured to map the sorted outputs of the neural network to features according to their sensitive attributes.
